(19) United States
(12) Patent Application Publication
(10) Pub. No.: US 2008/0304096 A1
(43) Pub. Date: Dec. 11, 2008

(54) SYSTEM AND METHOD FOR ADAPTIVE FILTER CHAIN DOCUMENT PROCESSING

(76) Inventor: Jose Elwin Simon Maglanque, Regents Park (AU)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/760,237

(22) Filed: Jun. 8, 2007

(51) Int. Cl. G06F 3/12; G06F 15/16; G06F 17/00

(52) U.S. Cl. 358/1.15; 709/201

(57) ABSTRACT

The subject application is directed to a system and method for adaptive filter chain document processing. Electronic documents are first received, with each document including processing control data representing a series of document processing operations associated with the corresponding document. The control data associated with each electronic document is then tested. An optimized series of document processing operations is then isolated based upon an output of the testing of the control data. Electronic documents are then routed to an associated document processor for completion of an optimized series of document processing operations.

### BACKGROUND OF THE INVENTION

The subject application is directed to generally to document processing. It is particularly applicable to document processing using filters which extract and perform one or more operations on electronic documents in a chained or pipelined fashion.

Electronic documents are generated by many applications, including word processing and computer aided design and drawing packages. Electronic documents are also created by operations such as scanning of tangible documents or receipt of electronic mail or facsimile messages.

Often electronic documents need to be submitted for printing, plotting, transmission, or the like. Traditionally, embedded properties or commands in the electronic document would dictate attributes for a document output, such as color, position, font, content, and the like. Specialized software in a document processing device, such as software embedded on a printer controller, would decode such information so as to perform associated operations on the document.

More recently, operating systems such as Microsoft Corporation's VISTA include a new printer format. This format builds on the extensible markup language (“XML”) that has become popular, and is referred to as the XML page specification (“XPS”). XPS processing is accomplished by use of a sequence of filters that are executed during the printing process.

The existing WINDOWS VISTA filter mechanism permits a sequence of filters to be executed on each document for which processing is desired. This feature allows some aspects of document processing to be completed locally, such as a user's computer or workstation, prior to submission to a document processing device for completion.

### SUMMARY OF THE INVENTION

In accordance with one embodiment of the subject application, there is provided a system and method for document processing using filters which extract and perform one or more operations on electronic documents in a chained or pipelined fashion.

Further, in accordance with one embodiment of the subject application, there is provided a system for adaptive filter chain document processing. The system comprises means adapted for receiving electronic documents, each electronic document including processing control data representative of a series of document processing operations associated therewith. The system also comprises testing means adapted for testing control data associated with received electronic documents and means adapted for isolating an optimized series of document processing operations in accordance with an output of the testing means. The system further comprises routing means adapted for routing electronic documents to an associated document processor for completion of an optimized series of document processing operations.

In one embodiment of the subject application, the control data includes data representative of discrete document processing instructions in the series thereof. In this embodiment, the associated document processor includes document processor filter means adapted for isolating at least one uncompleted document processing operation from the optimized series thereof prior to completion thereof.

In another embodiment of the subject application, the testing means is comprised of a local filter means.

In a further embodiment of the subject application, the testing means includes means adapted for testing a document processing operation for at least one operation from the group comprising load balancing, color management, and document structuring.

In yet another embodiment of the subject application, the document processor filter means includes means adapted for isolating an optimized series in accordance with at least one attribute included in the control data from a group comprising job type, job size, job priority, job origin, and document attributes.

Still further, in accordance with one embodiment of the subject application, there is provided a method for adaptive filter chain document processing in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for adaptive filter chain document processing according to one embodiment of the subject application;

FIG. 2 is a block diagram illustrating controller hardware for use in the system for adaptive filter chain document processing according to one embodiment of the subject application;

FIG. 3 is a functional diagram illustrating the controller for use in the system for adaptive filter chain document processing according to one embodiment of the subject application;

FIG. 4 is a block diagram illustrating a workstation for use in the system for adaptive filter chain document processing according to one embodiment of the subject application;

FIG. 5 is a flowchart illustrating a method for adaptive filter chain document processing according to one embodiment of the subject application; and

FIG. 6 is a flowchart illustrating a method for adaptive filter chain document processing according to one embodiment of the subject application.

### DETAILED DESCRIPTION OF THE PREFERRED EMBODIMENT

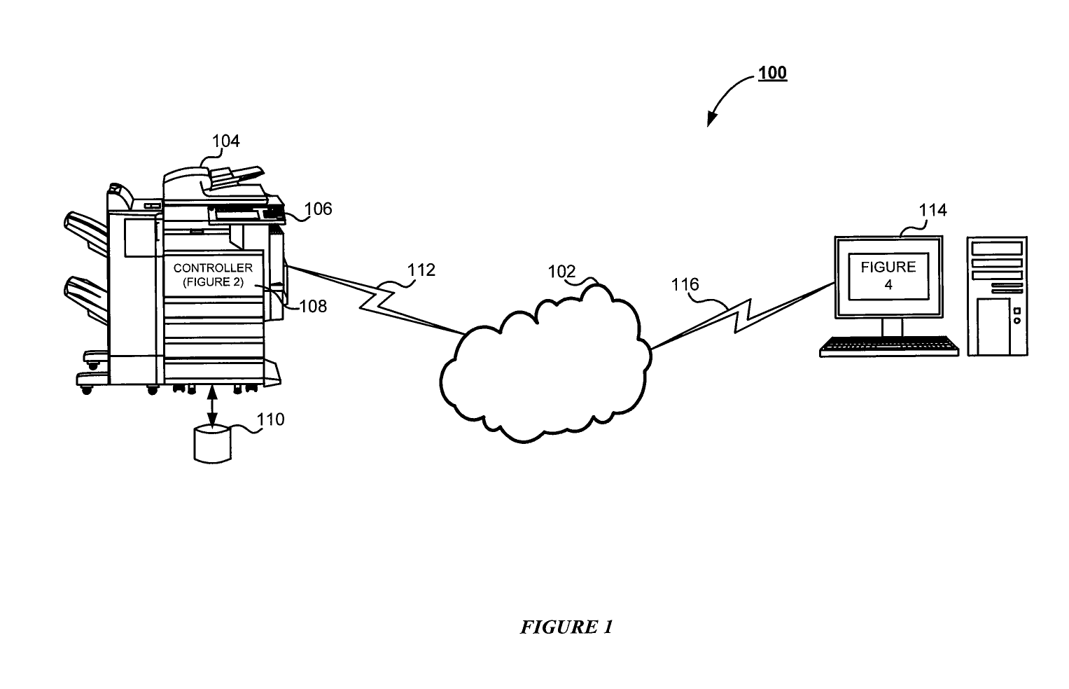

The subject application is directed to a system and method for adaptive filter chain document processing. In particular, the subject application is directed to a system and method for document processing using filters which extract and perform one or more operations on electronic documents in a chained or pipelined fashion. It will become apparent to those skilled in the art that the system and method described herein are suitably adapted to a plurality of varying electronic fields employing sequential processing, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for adaptive filter chain document processing in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

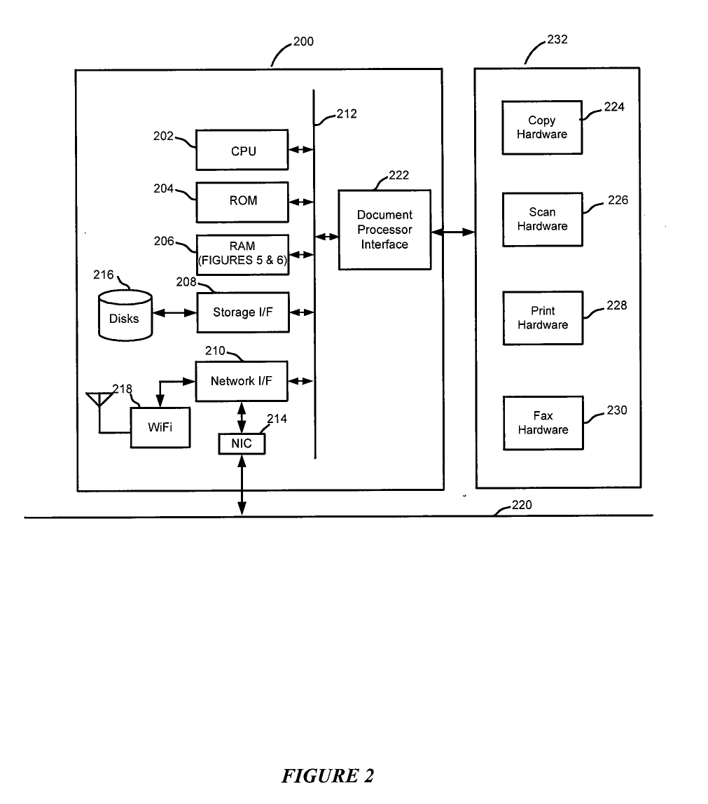

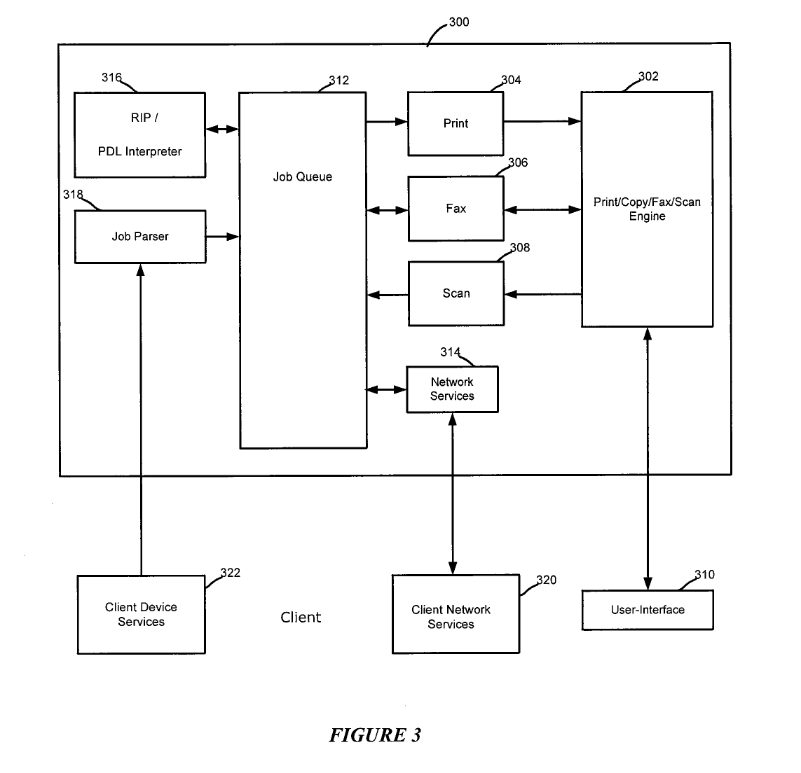

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for adaptive filter chain document processing of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

The system 100 illustrated in FIG. 1 further depicts a user device 114, in data communication with the computer network 102 via a communications link 116. It will be appreciated by those skilled in the art that the user device 114 is shown in FIG. 1 as a computer workstation for illustration purposes only. As will be understood by those skilled in the art, the user device 114 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with bus the 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The Parser 318 functions to interpret a received electronic document file and relay it to the job queue 312 for handling in connection with the afore-described functionality and components.

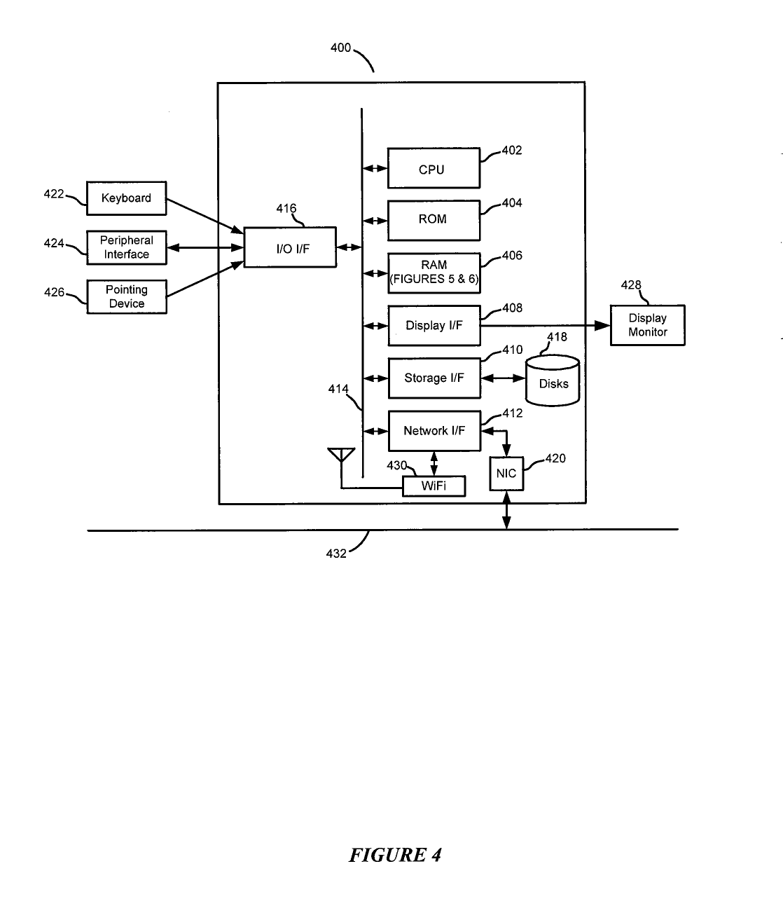

Turning now to FIG. 4, illustrated is a hardware diagram of a suitable workstation 400, shown in FIG. 1 as the user device 114, for use in connection with the subject system. A suitable workstation includes a processor unit 402 which is advantageously placed in data communication with read only memory 404, suitably non-volatile read only memory, volatile read only memory or a combination thereof, random access memory 406, display interface 408, storage interface 410, and network interface 412. In a preferred embodiment, interface to the foregoing modules is suitably accomplished via a bus 414.

The read only memory 404 suitably includes firmware, such as static data or fixed instructions, such as BIOS, system functions, configuration data, and other routines used for operation of the workstation 400 via CPU 402.

The random access memory 406 provides a storage area for data and instructions associated with applications and data handling accomplished by the processor 402.

The display interface 408 receives data or instructions from other components on the bus 414, which data is specific to generating a display to facilitate a user interface. The display interface 408 suitably provides output to a display terminal 428, suitably a video display device such as a monitor, LCD, plasma, or any other suitable visual output device as will be appreciated by one of ordinary skill in the art.

The storage interface 410 suitably provides a mechanism for non-volatile, bulk or long term storage of data or instructions in the workstation 400. The storage interface 410 suitably uses a storage mechanism, such as storage 418, suitably comprised of a disk, tape, CD, DVD, or other relatively higher capacity addressable or serial storage medium.

The network interface 412 suitably communicates to at least one other network interface, shown as network interface 420, such as a network interface card, and wireless network interface 430, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art. In the illustration, the network interface 420 is interconnected for data interchange via a physical network 432, suitably comprised of a local area network, wide area network, or a combination thereof.

An input/output interface 416 in data communication with the bus 414 is suitably connected with an input device 422, such as a keyboard or the like. The input/output interface 416 also suitably provides data output to a peripheral interface 424, such as a USB, universal serial bus output, SCSI, Firewire (IEEE 1394) output, or any other interface as may be appropriate for a selected application. Finally, the input/output interface 416 is suitably in data communication with a pointing device interface 426 for connection with devices, such as a mouse, light pen, touch screen, or the like.

In operation, electronic documents are first received, with each document including processing control data representing a series of document processing operations associated with the corresponding document. The control data associated with each electronic document is then tested. An optimized series of document processing operations is then isolated based upon an output of the testing of the control data. Electronic documents are then routed to an associated document processor for completion of an optimized series of document processing operations.

In accordance with one example embodiment of the subject application, a filter, a software driver, or other component associated with the user device 114 receives electronic documents from one or more associated applications. Preferably, the driver is associated with the operating system of the user device 114, such as VISTA by the Microsoft Corporation. In such an operating system, a printer format, such as the extensible markup language page specification, or XPS, is used for outputting electronic documents to an associated document processor, e.g., the document processing device 104. Each electronic document includes control data representing a series of document processing operations corresponding to the electronic document. According to one embodiment of the subject application, the control data includes, for example and without limitation, data representing discrete document processing instructions in the corresponding series of operations. The control data associated with each electronic document is then tested by the software driver via a local filter. As will be appreciated by those skilled in the art, a filter, as used herein, corresponds to a specialized program, or dedicated hardware component, that performs one or more functions, such as color management, load balancing, document structuring, and the like.

Based upon the results of the test, an optimized series of document processing operations are isolated using the control data. Preferably, such an optimized series of document processing operations is isolated in accordance with one or more attributes included within the control data, such as, for example and without limitation, a job type, a job size, a job priority, a job origin, a document attribute, or the like. Thus, in accordance with one embodiment of the subject application, the local filter determines, based upon the attributes associated with the control data, which additional filter or filters are necessary to complete document processing operations. An uncompleted document processing operation is then isolated from the optimized series of document processing operations prior to the completion thereof. A document processing operation is then tested for a load balancing operation, a color management operation, a document structuring operation, and the like. Thereafter, the software driver associated with the user device 114 then routes the received electronic documents to the document processing device 104 via the computer network 102 for completion of the optimized series of document processing operations.

According to a further example of the subject application, a user associated with the user device 114 is capable of generating a plurality of filters for pre-processing of electronic documents prior to the output thereof by an associated document processing device 104. That is, the filters contemplated herein perform certain document processing operations prior to the document processing device 104 completing a document processing operation on an electronic document. Thus, a software application, such as an XPS driver, resident on the user device 114, receives one or more electronic documents from various applications on the user device 114, e.g., PHOTOSHOP by Adobe Systems, Inc., POWERPOINT by Microsoft Corporation, or the like. Included with the received electronic documents is control data, corresponding to document attributes, discrete document processing instructions, or the like.

The control data is then analyzed by the driver to determine which filter or filters are available and capable of performing selected document processing operations on the received electronic documents. An optimized series of document processing operations is then isolated, or generated, according to the analysis of the control data. In accordance with one embodiment of the subject application, the optimized series is isolated using attributes included within the control data, such as, for example and without limitation, the job type, job size, job priority, job origin, document attributes, and the like. The skilled artisan will appreciate that the device driver generates a sequence or chain of filters to perform document processing operations based on the control data associated with the electronic documents. An uncompleted document processing operation is then isolated from the optimized series. A test is then conducted by a filter to determine the type of document processing operation corresponding to the uncompleted document processing operation. The electronic documents are then routed to an associated document processor, e.g., another filter, the document processing device 104, or the like, in accordance with the optimized series of document processing operations.

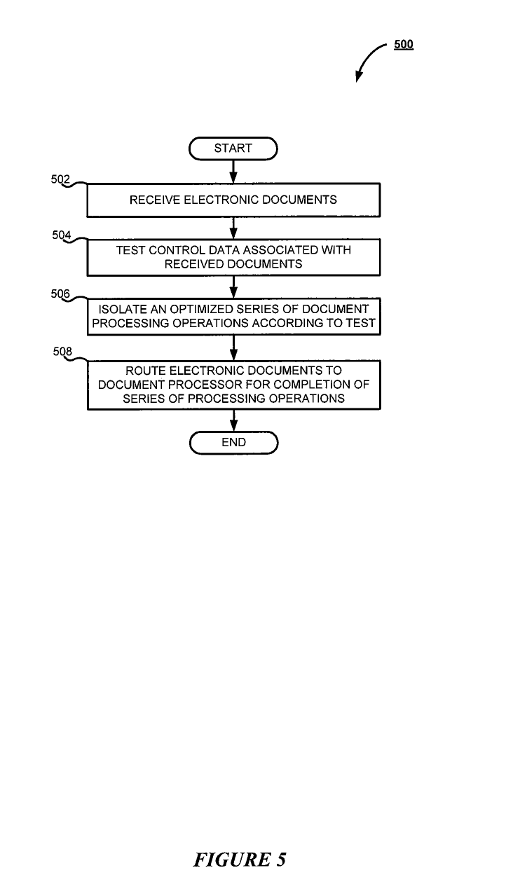

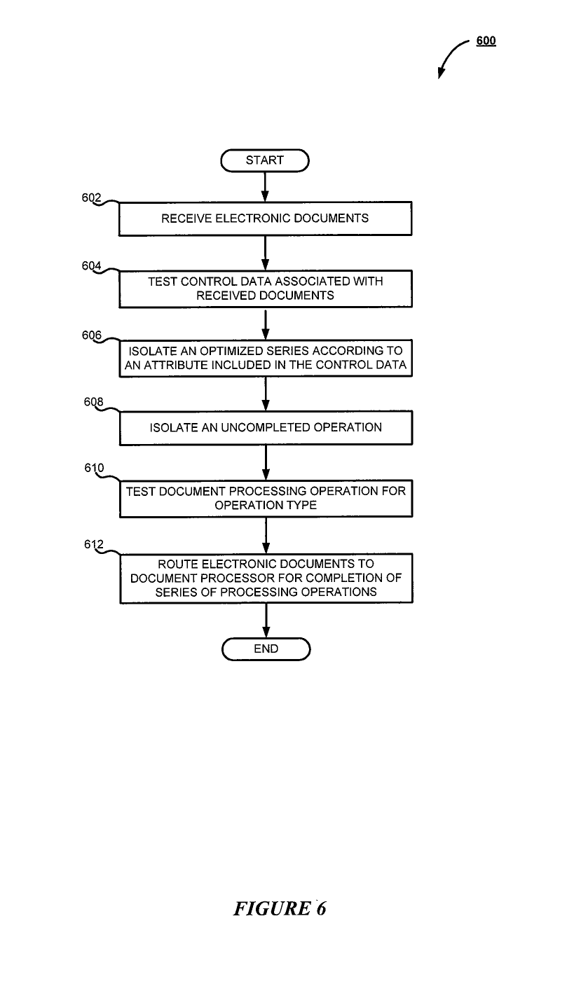

The skilled artisan will appreciate that the subject system 100 and components described above with respect to FIG. 1, FIG. 2, FIG. 3, and FIG. 4 will be better understood in conjunction with the methodologies described hereinafter with respect to FIG. 5 and FIG. 6. Turning now to FIG. 5, there is shown a flowchart 400 illustrating a method for adaptive filter chain document processing in accordance with one embodiment of the subject application. Beginning at step 502, electronic documents are received with each electronic document including processing control data representing a series of document processing operations associated therewith. At step 504, control data associated with the received electronic documents is tested. An optimized series of document processing operations is then isolated at step 506 in accordance with an output of the testing of the control data. At step 508, the electronic documents are routed to an associated document processor for completion of an optimized series of document processing operations.

Referring now to FIG. 6, there is shown a flowchart 600 illustrating a method for adaptive filter chain document processing in accordance with one embodiment of the subject application. The method depicted in FIG. 6 begins at step 602, whereupon one or more electronic documents, inclusive of control data, is received by a filter, software driver, or other component associated with the user device 114. In accordance with such an embodiment of the subject application, the control data includes, for example and without limitation, job type attributes, document attributes, job origin attributes, job size attributes, job priority attributes, or the like. In such an embodiment, the control data further corresponds to discrete document processing instructions. The control data associated with each received electronic document is then tested, at step 604, so as to isolate, at step 606, an optimized series of document processing operations in accordance with the job attributes of the control data. It will be appreciated by those skilled in the art that such testing is capable of being accomplished by a filter associated with the user device 114, whereupon the filter facilitates the performance of one or more associated document processing operations.

At step 608, an uncompleted document processing operation is isolated from the optimized series of document processing operations prior to the completion of the optimized series. The uncompleted operation is then tested, at step 610, so as to determine the type of document processing operation, e.g., load balancing, color management, document structuring, or the like. At step 612, the electronic documents are routed to an associated document processor for completion of a series of document processing operations.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for adaptive filter chain document processing comprising:
means adapted for receiving electronic documents, each electronic document including processing control data representative of a series of document processing operations associated therewith;
testing means adapted for testing control data associated with received electronic documents;
means adapted for isolating an optimized series of document processing operations in accordance with an output of the testing means; and
routing means adapted for routing electronic documents to an associated document processor for completion of an optimized series of document processing operations.

2. The system of claim 1 wherein:
control data includes data representative of discrete document processing instructions in the series thereof; and
the associated document processor includes document processor filter means adapted for isolating at least one uncompleted document processing operation from the optimized series thereof prior to completion thereof.

3. The system of claim 2 wherein the testing means is comprised of a local filter means.

4. The system of claim 2 wherein the testing means includes means adapted for testing a document processing operation for at least one operation from a group comprising load balancing, color management, and document structuring.

5. The system of claim 2 wherein the document processor filter means includes means adapted for isolating an optimized series in accordance with at least one attribute included in the control data from a group comprising job type, job size, job priority, job origin, and document attributes.

6. A method for adaptive filter chain document processing comprising the steps of:
receiving electronic documents, each electronic document including processing control data representative of a series of document processing operations associated therewith;
testing control data associated with received electronic documents;
isolating an optimized series of document processing operations in accordance with an output of the testing of control data; and
routing electronic documents to an associated document processor for completion of an optimized series of document processing operations.

7. The method of claim 6 wherein:
control data includes data representative of discrete document processing instructions in the series thereof; and
further comprising the step of isolating at least one uncompleted document processing operation from the optimized series thereof prior to completion thereof.

8. The method of claim 7 wherein the testing of control data is performed via of a local filter.

9. The method of claim 7 further comprising the step of testing a document processing operation for at least one operation from a group comprising load balancing, color management, and document structuring.

10. The method of claim 7 further comprising the step of isolating an optimized series in accordance with at least one attribute included in the control data from a group comprising job type, job size, job priority, job origin, and document attributes.

11. A computer-implemented method for adaptive filter chain document processing comprising the steps of:
receiving electronic documents, each electronic document including processing control data representative of a series of document processing operations associated therewith;
testing control data associated with received electronic documents;
isolating an optimized series of document processing operations in accordance with an output of the testing of control data; and
routing electronic documents to an associated document processor for completion of an optimized series of document processing operations.

12. The computer-implemented method of claim 11 wherein:
control data includes data representative of discrete document processing instructions in the series thereof; and
further comprising the step of isolating at least one uncompleted document processing operation from the optimized series thereof prior to completion thereof.

13. The computer-implemented method of claim 12 wherein the testing of control data is performed via of a local filter.

14. The computer-implemented method of claim 12 further comprising the step of testing a document processing operation for at least one operation from a group comprising load balancing, color management, and document structuring.

15. The computer-implemented method of claim 12 further comprising the step of isolating an optimized series in accordance with at least one attribute included in the control data from a group comprising job type, job size, job priority, job origin, and document attributes.
